(19) United States
(12) Patent Application Publication
(10) Pub. No.: US 2009/0120523 A1
(43) Pub. Date: May 14, 2009

(54) Jacketed pipe insulation

(76) Inventor: Edward Albert Bright, Littleton, CO (US)

Correspondence Address: JOHNS MANVILLE;Legal Department, 10100 West Ute Avenue, Littleton, CO, 80127, US

(21) Appl. No.: 11/985,180

(22) Filed: Nov. 14, 2007

(51) Int. Cl. F16L 11/00; C09J 5/04

(52) U.S. Cl. 138/141; 156/305; 138/149; 138/169; 138/170

(57) ABSTRACT

A method of installing pipe insulation includes a length of tubular insulation with a longitudinally extending slit so that the tubular insulation can be passed over and mounted on a length of pipe and a jacket overlaying the outer surface of the tubular insulation.

### FIELD OF ART

The present application relates to a pipe insulation assembly. This application also relates to a method of installing pipe insulation that includes a length of tubular insulation with a longitudinally extending slit so that the tubular insulation can be passed over and mounted on a length of pipe and a jacket overlaying the outer surface of the tubular insulation.

### BACKGROUND

Pipe insulation retards heat flow to or from the ambient environment, thereby conserving energy. Facing (or jacketing) is typically pre-attached to pipe insulation to make the installation of an aesthetically acceptable material as quick as possible by providing a method by which the insulation is held closed around the pipe. In some situations, the facing material also serves as a barrier to contaminants and water vapor. For example ASTM (C-547), Type I fiber glass pipe insulation sold in the United States is typically sold with a jacketing system pre-attached to the insulation. This jacketing system after final installation serves to hold the insulation closed, provide a moisture barrier, and be aesthetically pleasing visually.

The industry standard method for closure of the longitudinal seam is double sided tape (i.e., self-seal lap or SSL tape) applied to the inside of the jacketing material as close to the edge as possible. The installer removes a liner and presses the flap down to the jacketing material on the other side of the insulation slit. Many times the installer will then subsequently use outward clinch staples applied over the tape to ensure that the flap remains closed. In cases where a vapor barrier is required a mastic sealant is then applied over the staples to seal up the punctures made by the staples. Having to apply staples and mastic is a time consuming process. Further, the edges of the longitudinal flap often lift away from the jacketing material after sealing. A completely sealed final closure of the longitudinal seam where staples and mastic are not need to ensure the flap stays closed is highly desirable.

### SUMMARY

Provided is a method of installing pipe insulation comprising passing a length of pipe insulation over a length of pipe and mounting the length of pipe insulation on the length of pipe. The pipe insulation has a wall having a length with an outer cylindrical surface and an inner cylindrical surface for overlaying an outer surface of the length of pipe. The pipe insulation further has a longitudinally extending slit extending from the outer cylindrical surface to the inner cylindrical surface of the wall and for the length of the wall and a jacket overlaying the outer cylindrical surface of the wall. The jacket has a first lateral edge portion and a second lateral edge portion, the second lateral edge portion forming a longitudinally extending flap for overlapping the first lateral edge portion of the jacket. The longitudinally extending flap is overlapped over the first lateral edge portion of the jacket. The pipe insulation is sealed by applying a continuous adhesive to an exterior of the longitudinally extending flap and an exterior area of the jacket adjacent the first lateral edge portion.

Also provided is a sealed pipe insulation assembly comprising a wall having a length with an outer cylindrical surface and an inner cylindrical surface for overlaying an outer surface of the length of pipe. A longitudinally extending slit extends from the outer cylindrical surface to the inner cylindrical surface of the wall and for the length of the wall. A jacket overlays the outer cylindrical surface of the wall. The jacket has a first lateral edge portion and further has a second lateral edge portion that forms a longitudinally extending flap for overlapping the first lateral edge portion of the jacket. Applied to an exterior of the longitudinally extending flap and an exterior area of the jacket adjacent the first lateral edge portion is a continuous adhesive.

### BRIEF DESCRIPTION OF THE DRAWINGS

FIG. 1 is an end view of pipe insulation showing two methods of sealing the pipe insulation. FIG. 1A shows a traditional method of sealing the pipe insulation, while FIG. 1B shows a method of sealing the pipe insulation disclosed herein.

### DETAILED DESCRIPTION

The presently disclosed method of installing a pipe insulation solves the problems discussed above that are currently encountered in the installation of pipe insulation assemblies. The presently disclosed method of installing pipe insulation includes passing a length of pipe insulation over a length of pipe and mounting the length of pipe insulation on the length of pipe. The pipe insulation has a wall with an outer cylindrical surface and an inner cylindrical surface for overlaying an outer surface of the length of pipe. The wall has a length. The pipe insulation further has a longitudinally extending slit extending from the outer cylindrical surface to the inner cylindrical surface of the wall and for the length of the wall and a jacket overlaying the outer cylindrical surface of the wall. The jacket has a first lateral edge portion and a second lateral edge portion, the second lateral edge portion forming a longitudinally extending flap for overlapping the first lateral edge portion of the jacket. The longitudinally extending flap is overlapped over the first lateral edge portion of the jacket. The pipe insulation is sealed by applying a continuous adhesive to an exterior of the longitudinally extending flap and an exterior area of the jacket adjacent the first lateral edge portion.

A longitudinally and radially extending slit extends from the outer surface to the inner surface of the wall and for the length of the wall so that the pipe insulation can be easily flexed open, passed over, and mounted on the length of pipe. Where the tubular insulation is less flexible or more flexibility is desired for passing the pipe insulation over a pipe, the slit may also extend part of the way through a diametrically opposed portion of the wall to provide the pipe insulation with more flexibility for being opened, passed over, and mounted on a length of pipe or the slit may extend completely through a diametrically opposed portion of the wall to severe the tubular insulation into two sections with the jacket holding the sections together and providing the pipe insulation with more flexibility for being opened, passed over, and mounted on a length of pipe.

The jacket can be bonded to the outer cylindrical surface of the wall. The slit can have a first longitudinally extending outer edge and a second longitudinally extending outer edge, and the first lateral edge portion can extend along the first longitudinally extending outer edge of the slit, while the second lateral edge portion extends along the slit in proximity to the second outer edge of the slit. Then, overlapping the longitudinally extending flap over the first lateral edge portion of the jacket results in the longitudinally extending flap overlapping the slit. The adhesive, or tape, for example, single sided tape, can be a pressure sensitive adhesive, such as, but not limited to, an acrylic adhesive, for example, in the form of pressure sensitive tape.

The length of tubular insulation used in the pipe insulation may be made of various insulation materials, such as, but not limited to, fiberglass, mineral wool, and/or other fibrous insulation materials or foam insulation materials. However, fiberglass is a preferred insulation material. For example, the tubular insulation of the pipe insulation may be made from glass fibers bonded together with a thermosetting resin, such as the tubular insulation used in a jacketed pipe insulation marketed by Johns Manville International, Inc., under the trade designation Micro-Lok® fiber glass pipe insulation. Jacketed pipe insulation such as Micro-Lok® pipe insulation is suitable for installation over hot, cold, concealed and exposed piping systems with operating temperatures ranging from 0° F. (−18° C.) to 850° F. (454° C.). Jacketed pipe insulation such as Micro-Lok® pipe insulation is for example marketed in lengths of 36 inches (0.92 m); and in wall thicknesses ranging from 0.5 inches (1.27 cm) to 3 inches (7.62 cm) for insulating pipe having nominal outside diameters ranging from 0.05 to 8 inches (1.3 to 20.3 cm). The jacket of the pipe insulation can function as a vapor retarder and be made from a reinforced facing material, such as, but not limited to, a scrim reinforced polymeric sheet material, or Foil-Scrim-Kraft (FSK) facing.

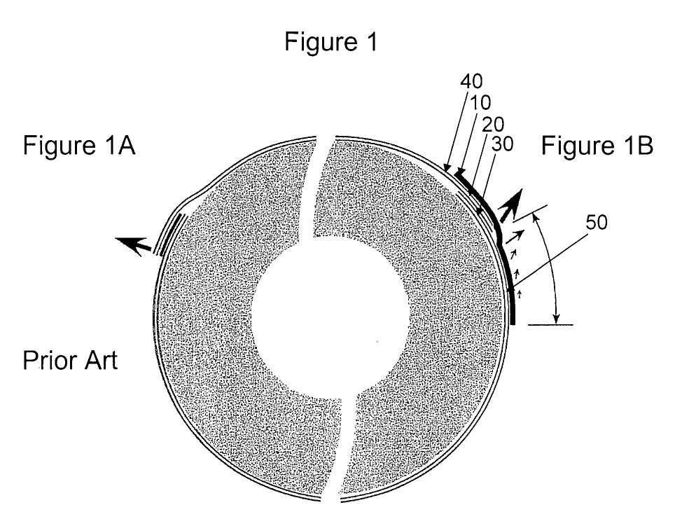

FIG. 1 is an end view of a pipe insulation showing two methods of sealing the pipe insulation. FIG. 1A shows a traditional method of sealing the pipe insulation, while FIG. 1B shows a method of sealing the pipe insulation disclosed herein. In FIG. 1A, the “lifting” force exerted by the flap is concentrated at a single point, represented by the sole arrow. In contrast, in FIG. 1B, the “lifting” force exerted by the flap is distributed over a larger area, represented by the numerous arrows. Without wishing to be bound by any theory, it is believed that the distribution of the “lifting” force over a larger area improves the ability of the adhesive to stay in place once applied, by changing some of the “lifting” force vector from a “peeling” vector to a “shearing” vector, as further represented by the numerous arrows of FIG. 1B. As shown in FIG. 1B, the pipe insulation is sealed by a continuous (strip or layer of) adhesive 10 applied to: (1) an exterior of the longitudinally extending flap 20, which overlaps the first lateral edge portion 30 and which is formed from the second lateral edge portion 40; and (2) an exterior area of the jacket 50 adjacent the first lateral edge portion.

While various embodiments have been described, it is to be understood that variations and modifications can be resorted to as will be apparent to those skilled in the art. Such variations and modifications are to be considered within the purview and scope of the claims appended hereto.

What is claimed is:

1. A method of installing pipe insulation comprising:
passing a length of pipe insulation over a length of pipe; the pipe insulation having a wall with an outer cylindrical surface and an inner cylindrical surface for overlaying an outer surface of the length of pipe; the wall having a length; the pipe insulation further having a longitudinally extending slit extending from the outer cylindrical surface to the inner cylindrical surface of the wall and for the length of the wall; the pipe insulation further having a jacket overlaying the outer cylindrical surface of the wall; the jacket having a first lateral edge portion; the jacket further having a second lateral edge portion that forms a longitudinally extending flap for overlapping the first lateral edge portion of the jacket;
mounting the length of pipe insulation on the length of pipe;
overlapping the longitudinally extending flap over the first lateral edge portion of the jacket;
sealing the pipe insulation by applying a continuous adhesive to an exterior of the longitudinally extending flap and an exterior area of the jacket adjacent the first lateral edge portion.

2. The method of claim 1, wherein the jacket is bonded to the outer cylindrical surface of the wall.

3. The method of claim 1, wherein:
the slit has a first longitudinally extending outer edge and a second longitudinally extending outer edge;
the first lateral edge portion extends along the first longitudinally extending outer edge of the slit;
the second lateral edge portion extends along the slit in proximity to the second outer edge of the slit; and
overlapping the longitudinally extending flap over the first lateral edge portion of the jacket results in the longitudinally extending flap overlapping the slit.

4. The method of claim 1, wherein the adhesive comprises tape.

5. The method of claim 1, wherein the adhesive comprises single sided tape.

6. The method of claim 1, wherein the adhesive comprises a pressure sensitive adhesive.

7. The method of claim 1, wherein the adhesive comprises acrylic adhesive.

8. The method of claim 1, wherein the adhesive comprises a pressure sensitive tape.

9. The method of claim 1, wherein the wall comprises a material selected from the group consisting of fiberglass, mineral wool, fibrous insulation materials, foam insulation materials, and combinations thereof.

10. The method of claim 1, wherein the wall comprises fiberglass.

11. The method of claim 1, wherein the wall comprises glass fibers bonded together with a thermosetting resin.

12. The method of claim 1, wherein the pipe has an operating temperature ranging from 0° F. (−18° C.) to 850° F. (454° C.).

13. The method of claim 1, wherein the wall has a thicknesses ranging from 0.5 inches (1.27 cm) to 3 inches (7.62 cm).

14. The method of claim 1, wherein the pipe has a nominal outside diameter ranging from 0.5 to 8 inches (1.3 to 20.3 cm).

15. The method of claim 1, wherein the jacket functions as a vapor retarder.

16. The method of claim 1, wherein the jacket comprises a reinforced facing material.

17. The method of claim 1, wherein the jacket comprises a scrim reinforced polymeric sheet material.

18. A sealed pipe insulation assembly comprising:
a wall with an outer cylindrical surface and an inner cylindrical surface for overlaying an outer surface of the length of pipe; the wall having a length;
a longitudinally extending slit extending from the outer cylindrical surface to the inner cylindrical surface of the wall and for the length of the wall;
a jacket overlaying the outer cylindrical surface of the wall; the jacket having a first lateral edge portion; the jacket further having a second lateral edge portion that forms a longitudinally extending flap for overlapping the first lateral edge portion of the jacket;
a continuous adhesive applied to an exterior of the longitudinally extending flap and an exterior area of the jacket adjacent the first lateral edge portion.

19. The sealed pipe insulation assembly of claim 18, wherein the jacket is bonded to the outer cylindrical surface of the wall.

20. The sealed pipe insulation assembly of claim 18, wherein:
the slit has a first longitudinally extending outer edge and a second longitudinally extending outer edge;
the first lateral edge portion extends along the first longitudinally extending outer edge of the slit;
the second lateral edge portion extends along the slit in proximity to the second outer edge of the slit; and
the longitudinally extending flap overlaps the slit.
